(19) United States
(12) Patent Application Publication
(10) Pub. No.: US 2025/0119261 A1
(43) Pub. Date: Apr. 10, 2025

(54) WIRELESS COMMUNICATION METHOD, TERMINAL DEVICE, AND CHIP

(71) Applicant: GUANGDONG OPPO MOBILE TELECOMMUNICATIONS CORP., LTD., Dongguan (CN)

(72) Inventors: Bingxue LENG, Dongguan (CN); Qianxi LU, Dongguan (CN); Boyuan ZHANG, Dongguan (CN)

(21) Appl. No.: 18/981,793

(22) Filed: Dec. 16, 2024

Related U.S. Application Data
(63) Continuation of application No. PCT/CN2022/100408, filed on Jun. 22, 2022.

(51) Int. Cl. H04L 5/00; H04W 72/1263; H04W 72/231; H04W 72/563

(52) U.S. Cl. CPC H04L 5/0057; H04W 72/1263; H04W 72/231; H04W 72/563

(57) ABSTRACT

A wireless communication method and a terminal device are provided. The wireless communication method includes the following. A first terminal receives first indication information, where the first indication information indicates the first terminal to send a first channel state information (CSI) report. The first terminal determines a first carrier, where the first carrier is used for sending the first CSI report.

### CROSS-REFERENCE TO RELATED APPLICATION(S)

This application is a continuation of International Application No. PCT/CN2022/100408, filed Jun. 22, 2022, the entire disclosure of which is hereby incorporated herein by reference.

### TECHNICAL FIELD

Embodiments of the disclosure relate to the field of communication, and more particularly, to a wireless communication method, a terminal device, and a chip.

### BACKGROUND

A sidelink (SL)-channel state information (CSI) reporting procedure is used for providing SL-CSI for a peer device in unicast communication, so as to facilitate the peer device to perform corresponding access stratum (AS) parameter adjustment, which includes but is not limited to power control and modulation/demodulation mode adjustment.

An existing new radio (NR) SL only supports a single carrier and a single-carrier-based CSI reporting mechanism. After a multi-carrier mechanism is introduced, a corresponding CSI reporting mechanism needs to be proposed.

### SUMMARY

According to a first aspect, a wireless communication method is provided. The method is applied to a first terminal. The method includes the following. First indication information is received, where the first indication information indicates the first terminal to send a first channel state information (CSI) report. A first carrier is determined, where the first carrier is used for sending the first CSI report.

According to a second aspect, a wireless communication method is provided. The method is applied to a second terminal. The method includes the following. First indication information is sent, where the first indication information indicates a first terminal to send a first CSI report.

According to a third aspect, a wireless communication method is provided. The method is applied to a network device. The method includes the following. A first scheduling request (SR) and/or a first buffer status report (BSR) sent by a first terminal is received. A first resource is determined according to the first SR and/or the first BSR, where the first resource is used for the first terminal to send a first CSI report.

According to a fourth aspect, a first terminal device is provided. The first terminal device is configured to perform the method in the first aspect or various implementations of the first aspect. Specifically, the first terminal device includes functional modules configured to perform the method in the first aspect or various implementations of the first aspect.

According to a fifth aspect, a second terminal device is provided. The second terminal device is configured to perform the method in the second aspect or various implementations of the second aspect. Specifically, the second terminal device includes functional modules configured to perform the method in the second aspect or various implementations of the second aspect.

According to a sixth aspect, a network device is provided. The network device is configured to perform the method in the third aspect or various implementations of the third aspect. Specifically, the network device includes functional modules configured to perform the method in the third aspect or various implementations of the third aspect.

According to a seventh aspect, a first terminal device is provided. The first terminal device includes a processor and a memory. The memory is configured to store computer programs. The processor is configured to invoke and execute the computer programs stored in the memory, so as to perform the method in the first aspect or various implementations of the first aspect.

According to an eighth aspect, a second terminal device is provided. The second terminal device includes a processor and a memory. The memory is configured to store computer programs. The processor is configured to invoke and execute the computer programs stored in the memory, so as to perform the method in the second aspect or various implementations of the second aspect.

According to a ninth aspect, a network device is provided. The network device includes a processor and a memory. The memory is configured to store computer programs. The processor is configured to invoke and execute the computer programs stored in the memory, so as to perform the method in the third aspect or various implementations of the third aspect.

According to a tenth aspect, a chip is provided. The chip is configured to implement the method in any one of the first aspect to the third aspect or various implementations of the first aspect to the third aspect. Specifically, the chip includes a processor. The processor is configured to invoke and execute computer programs stored in a memory, to perform the method in any one of the first aspect to the third aspect or various implementations of the first aspect to the third aspect.

According to an eleventh aspect, a computer-readable storage medium is provided. The computer-readable storage medium is configured to store computer programs which are operable with a computer to perform the method in any one of the first aspect to the third aspect or various implementations of the first aspect to the third aspect.

According to a twelfth aspect, a computer program product is provided. The computer program product includes computer program instructions which are operable with a computer to perform the method in any one of the first aspect to the third aspect or various implementations of the first aspect to the third aspect.

According to a thirteenth aspect, a computer program is provided. The computer program, when executed by a computer, is operable with the computer to perform the method in any one of the first aspect to the third aspect or various implementations of the first aspect to the third aspect.

### BRIEF DESCRIPTION OF THE DRAWINGS

FIG. 1 is a schematic architectural diagram of a communication system to which embodiments of the disclosure are applied.

FIG. 2 is a schematic architectural diagram of another communication system to which embodiments of the disclosure are applied.

FIG. 3 is a flowchart of a wireless communication method provided in embodiments of the disclosure.

FIG. 4 is a schematic interaction diagram of a wireless communication method provided in embodiments of the disclosure.

FIG. 5 is a schematic interaction diagram of another wireless communication method provided in embodiments of the disclosure.

FIG. 6 is a schematic block diagram of a terminal device provided in embodiments of the disclosure.

FIG. 7 is a schematic block diagram of another terminal device provided in embodiments of the disclosure.

FIG. 8 is a schematic block diagram of a network device provided in embodiments of the disclosure.

FIG. 9 is a schematic block diagram of a communication device provided in embodiments of the disclosure.

FIG. 10 is a schematic block diagram of a chip provided in embodiments of the disclosure.

FIG. 11 is a schematic block diagram of a communication system provided in embodiments of the disclosure.

### DETAILED DESCRIPTION

The following will describe technical solutions of embodiments of the disclosure with reference to the accompanying drawings in embodiments of the disclosure. Apparently, embodiments described herein are merely some embodiments, rather than all embodiments, of the disclosure. Based on the embodiments of the disclosure, all other embodiments obtained by those of ordinary skill in the art without creative effort shall fall within the protection scope of the disclosure.

The technical solutions of embodiments of the disclosure are applicable to various communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (WiFi), a 5th-generation (5G) communication system, or other communication systems, etc.

Generally speaking, a conventional communication system generally supports a limited quantity of connections and therefore is easy to implement. However, with development of communication technology, a mobile communication system will not only support conventional communication but also support, for example, device to device (D2D) communication, machine to machine (M2M) communication, machine type communication (MTC), vehicle to vehicle (V2V) communication, or vehicle to everything (V2X) communication, etc. Embodiments of the disclosure can also be applied to these communication systems.

Optionally, the communication system in embodiments of the disclosure can be applied to a carrier aggregation (CA) scenario, or can be applied to a dual connectivity (DC) scenario, or can be applied to a standalone (SA) network deployment scenario.

Optionally, the communication system in embodiments of the disclosure is applicable to an unlicensed spectrum, and an unlicensed spectrum can be regarded as a shared spectrum. Alternatively, the communication system in embodiments of the disclosure is applicable to a licensed spectrum, and a licensed spectrum can be regarded as a non-shared spectrum.

Various embodiments of the disclosure are described in connection with a network device and a terminal device. The terminal device can also be referred to as a user equipment (UE), an access terminal, a subscriber unit, a subscriber station, a mobile station, a remote station, a remote terminal, a mobile device, a user terminal, a terminal, a wireless communication device, a user agent, or a user device, etc.

The terminal device can be a station (ST) in a WLAN, a cellular radio telephone, a cordless telephone, a session initiation protocol (SIP) telephone, a wireless local loop (WLL) station, a personal digital assistant (PDA), various devices with wireless communication functions such as a handheld device or a computing device, other processing devices coupled with a wireless modem, an in-vehicle device, a wearable device, and a terminal device in a next-generation communication system, for example, a terminal device in an NR network, or a terminal device in a future evolved public land mobile network (PLMN), etc.

In embodiments of the disclosure, the terminal device can be deployed on land, which includes indoor or outdoor, handheld, wearable, or in-vehicle. The terminal device can also be deployed on water (such as ships, etc.). The terminal device can also be deployed in the air (such as airplanes, balloons, satellites, etc.).

In embodiments of the disclosure, the terminal device can be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city, or a wireless terminal device in smart home, etc.

By way of explanation rather than limitation, in embodiments of the disclosure, the terminal device can also be a wearable device. The wearable device can also be called a wearable smart device, which is a generic term of wearable devices obtained through intelligent design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or part of functions of a smart phone, and for example, various types of smart bands and smart jewelries for physical monitoring, of which each is dedicated to application functions of a certain type and required to be used together with other devices such as a smart phone.

In embodiments of the disclosure, the network device can be a device configured to communicate with a mobile device, and the network device can be an access point (AP) in a WLAN, a base transceiver station (BTS) in GSM or CDMA, or can be a Node B (NB) in WCDMA, or can be an evolutional Node B (eNB or eNodeB) in LTE, or a relay station or AP, or an in-vehicle device, a wearable device, a network device or base station (gNB) in an NR network, a network device in a future evolved PLMN, or a network device in an NTN, etc.

By way of explanation rather than limitation, in embodiments of the disclosure, the network device can be mobile. For example, the network device can be a mobile device. Optionally, the network device can be a satellite or a balloon base station. For example, the satellite can be a low earth orbit (LEO) satellite, a medium earth orbit (MEO) satellite, a geostationary earth orbit (GEO) satellite, a high elliptical orbit (HEO) satellite, etc. Optionally, the network device can also be a base station deployed on land or water.

In embodiments of the disclosure, the network device can serve a cell, and the terminal device communicates with the network device on a transmission resource (for example, a frequency-domain resource or a spectrum resource) for the cell. The cell can be a cell corresponding to the network device (for example, a base station). The cell can belong to a macro base station, or can belong to a base station corresponding to a small cell. The small cell can include: a metro cell, a micro cell, a pico cell, a femto cell, and the like. These small cells are characterized by small coverage and low transmission power and are adapted to provide data transmission service with high-rate.

It should be understood that, the terms “system” and “network” herein are usually used interchangeably throughout this disclosure. The term “and/or” herein only describes an association between associated objects, which means that there can be three relationships. For example, A and/or B can mean A alone, both A and B exist, and B alone. In addition, the character “/” herein generally indicates that the associated objects are in an “or” relationship.

Terms used in the implementations of the disclosure are merely intended for explaining embodiments of the disclosure rather than limiting the disclosure. The terms “first”, “second”, “third”, “fourth”, and the like used in the specification, the claims, and the accompany drawings of the disclosure are used to distinguish different objects rather than describe a particular order. In addition, the terms “include”, “comprise”, and “have” as well as variations thereof are intended to cover non-exclusive inclusion.

It should be understood that, “indication” referred to in embodiments of the disclosure can be a direct indication, can be an indirect indication, or can mean that there is an association. For example, A indicates B can mean that A directly indicates B, for instance, B can be obtained according to A; can mean that A indirectly indicates B, for instance, A indicates C, and B can be obtained according to C; or can mean that that there is an association between A and B.

In the elaboration of embodiments of the disclosure, the term “correspondence” can mean that there is a direct or indirect correspondence between the two, can mean that there is an association between the two, or can mean a relationship of indicating and indicated or configuring and configured, etc.

In embodiments of the disclosure, the “pre-defined” or “preconfigured” can be implemented by pre-storing a corresponding code or table in a device (for example, including the terminal device and the network device) or in other manners that can be used for indicating related information, and the disclosure is not limited in this regard. For example, the “pre-defined” can mean defined in a protocol.

In embodiments of the disclosure, the “protocol” can refer to a communication standard protocol, which can include, for example, an LTE protocol, an NR protocol, and a protocol applied to a future communication system, and the disclosure is not limited in this regard.

Before introducing the technical solutions of the disclosure, some related art related to the disclosure is firstly introduced and elaborated. The following related art as an optional scheme can be arbitrarily combined with the technical solutions of embodiments of the disclosure, which shall all belong to the protection scope of embodiments of the disclosure. Embodiments of the disclosure include at least some of the following.

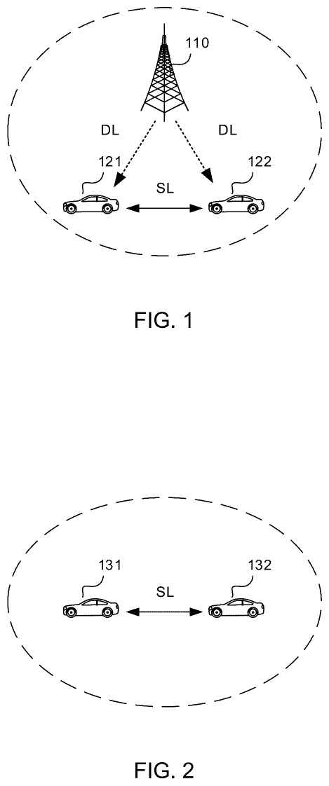

FIG. 1 is a schematic diagram of a communication system to which embodiments of the disclosure can be applied. A transmission resource for in-vehicle terminals (an in-vehicle terminal 121 and an in-vehicle terminal 122) is allocated by a base station 110, and the in-vehicle terminal performs data transmission over a sidelink (SL) on the resource allocated by the base station 110. Specifically, the base station 110 may allocate to the terminal a resource for single transmission, or may allocate to the terminal a resource for semi-persistent transmission.

FIG. 2 is a schematic diagram of another communication system to which embodiments of the disclosure can be applied. In-vehicle terminals (an in-vehicle terminal 131 and an in-vehicle terminal 132) select a transmission resource autonomously from SL resources to perform data transmission. Optionally, the in-vehicle terminal may select a transmission resource randomly, or select a transmission resource by means of sensing.

LTE D2D/V2X: D2D communication is a terminal-to-terminal SL transmission technology, and is also referred to as an SL communication technology. Different from a traditional cellular system in which communication data is received or transmitted by a base station, in a V2X system, D2D direct communication is adopted, which therefore has higher spectral efficiency and lower transmission delay. In the 3^{rd} generation partnership project (3GPP), two transmission modes are defined, namely mode A and mode B.

Mode A: a transmission resource for a terminal device is allocated by an access-network device (such as a base station). The terminal device transmits communication data over an SL on the transmission resource allocated by the access-network device. The access-network device can allocate to the terminal device a transmission resource for single transmission, or can allocate to the terminal device a transmission resource for semi-persistent transmission.

Mode B: the terminal device selects a transmission resource autonomously from a resource pool to transmit communication data. Specifically, the terminal device may select a transmission resource from the resource pool by means of sensing, or may select a transmission resource randomly from the resource pool.

In 3GPP, D2D is studied in different phases.

Proximity based service (ProSe): D2D communication in release 12/13 (Rel-12/13) is studied with regard to a ProSe scenario, which is mainly intended for public security services. In ProSe, time locations of a resource pool are configured, for example, the resource pool is non-consecutive in time domain, so that a terminal (UE) can implement discontinuous transmission or reception of data over an SL, thereby realizing power saving.

V2X: In Rel-14/15, a V2X system is studied with regard to a V2V communication scenario, and is mainly intended for V2V communication services and vehicle-to-pedestrian (V2P) communication services with relatively high-speed movement. In V2X, since an in-vehicle system can continuously supply power, power efficiency is not a major issue. However, delay of data transmission is a major issue, and therefore, when designing a system, a terminal device is required to support continuous transmission and reception.

Further-enhanced D2D (FeD2D): In Rel-14, this scenario is studied with regard to access of a wearable device to a network via a mobile phone, and is mainly intended for a low-speed movement scenario and a low-power access scenario. In FeD2D, in a pre-research stage, it is concluded by 3GPP that a network device may configure a discontinuous reception (DRX) parameter for a remote UE via a relay UE. However, since the project does not yet enter a standardization stage, there is no conclusion on specific details regarding how to perform DRX configuration.

NR V2X: On the basis of LTE V2X, NR V2X is not limited to a broadcast scenario, but is further extended to a unicast scenario and a groupcast scenario, and the application of V2X is studied in these scenarios. Similar to LTE V2X, two resource grant modes, namely mode A (referred to as mode-1 in NR V2X) and mode B (referred to as mode-2 in NR V2X), are defined in NR V2X. In addition, a user can be in a mixed mode, that is, obtain a resource in both mode-1 and mode-2. The resource can be indicated by an SL grant, i. e. the SL grant is indicative of a time-frequency location of a corresponding physical sidelink control channel (PSCCH) resource and physical sidelink shared channel (PSSCH) resource.

Different from LTE V2X, in NR V2X, besides no-feedback hybrid automatic repeat request (HARQ) retransmission that is initiated autonomously by the UE, feedback-based HARQ retransmission is introduced, and is applied to not only unicast communication but also groupcast communication.

LTE-V2X CA: Carrier selection in LTE-V2X CA is implemented by means of the following mechanism. An upper layer configures a mapping between a service type and a carrier, that is, for a certain service type, the upper layer indicates an available carrier (set) to an access stratum (AS). Further, the AS configures a carrier set available for each logical channel and a channel busy ratio (CBR) measurement threshold for each resource pool with regard to data priority. The UE measures a CBR value of a resource pool and compares the CBR value with a CBR threshold corresponding to the priority of data to-be-transmitted; and if the measured value is lower than the threshold, the carrier is considered to be available.

NR UE-universal mobile telecommunication system (UMTS) terrestrial radio access network (UE-UTRAN, Uu) CA: CA is a bandwidth-extension technology supported since an advanced LTE standard. Multiple component carriers (CC) can be aggregated together and received or sent simultaneously by one UE. With regard to the range of aggregated carriers, CA can be classified into intra-band CA and inter-band CA. Intra-band CA is mainly used for a scenario in which a cell carrier bandwidth is greater than a single-carrier bandwidth capability of a UE. In this case, the UE can implement a “wide carrier” operation by means of CA. For example, if the base station supports a 300 megahertz (MHZ) carrier but the UE only supports at most a 100 MHz carrier, the UE can implement a wideband operation beyond 100 MHz by means of CA. Carriers aggregated can be adjacent carriers or can be non-adjacent carriers.

When a terminal communicates with a network through CA, a primary cell (PCell) and a secondary cell (SCell) can be both configured. In NR R15, a beam failure recovery mechanism is designed for a PCell and a primary secondary cell (PSCell), in which there are four major functional modules (or referred to as major steps): beam failure detection (BFD), new beam identification (NBI), beam failure recovery request (BFRQ), and network response.

The terminal performs measurement on a physical downlink control channel (PDCCH), and determines quality of a link corresponding to a downlink (DL) transmit beam. If the quality of the corresponding link is very poor, it is considered that beam failure occurs to the DL beam. Further, the terminal measures a set of candidate beams, and selects a beam satisfying a certain threshold from the candidate beams as a new beam. Then the terminal notifies occurrence of beam failure and reports the new beam to the network through a BFRQ procedure. After receiving BFRQ information sent by the terminal, the network knows that beam failure occurs to the terminal, and sends a PDCCH on the new beam. If the PDCCH sent by the network is received by the terminal on the new beam, the terminal considers that network response information is correctly received, and in this way, the beam failure recovery procedure is completed successfully.

An SL-channel state information (CSI) reporting procedure is used for providing SL-CSI for a peer UE in unicast communication, so as to facilitate the peer UE to perform corresponding AS parameter adjustment, which includes but is not limited to power control and modulation/demodulation mode adjustment.

For a triggering condition of CSI reporting, a radio resource control (RRC) layer can configure a latency threshold to control the SL-CSI reporting procedure. Specifically, for the case where SL-CSI reporting has been triggered by a peer UE, if the UE has obtained successfully an SL grant for the peer UE within the latency threshold, the UE generates a CSI report for the peer UE accordingly and sends the CSI report; otherwise, it can be considered that the SL-CSI expires even if the SL-CSI has been generated, in other words, the SL-CSI is unable to reflect promptly channel quality of the UE and channel quality of the peer UE. Therefore, even if the SL grant for the peer UE has been obtained, transmission of the CSI report will still be cancelled. In addition, for the case where the UE is configured with a network scheduling-based resource selection mode, if the SL grant cannot fulfil the latency threshold, the UE may trigger a scheduling request (SR) to obtain the SL grant.

An SL logical channel prioritization (LCP) procedure refers to a procedure of prioritizing different logical channels and determining transmission of the amounts of data transmitted on different logical channels/media access control-control elements (MAC CE) when generating a MAC protocol data unit (MAC PDU).

Restriction conditions considered for NR-V2X are as follows:

If a current configured grant is configured grant Type 1, configured grant Type 1 is allowed to be used for transmission of data carried on the logical channel. According to a configured grant list associated with the logical channel, the current configured grant is allowed to be used for transmission of the data carried on the logical channel.

Then, from the set of logical channels that satisfy the conditions, it is necessary to further select a logical channel(s) for carrying, and determine the amount of data that can be carried on each logical channel, which specifically includes two steps.
Step one, select a destination address, which has a logical channel with the highest priority among current candidate logical channels in the SL logical channels that have data available for transmission and belong to the destination address.
Step two, select a logical channel from the logical channels belonging to the selected destination address, resources are allocated to an SL logical channel with the highest priority among logical channels belonging to the selected destination address and satisfy the above restriction conditions.

Both LTE-V2X and NR-V2X support network scheduling-based data transmission, which includes mode 1 and mode 3 in LTE-V2X and mode 1 in NR-V2X. When the UE works in the above mode, a resource grant for SL data transmission comes from a network, i. e. the network issues a resource grant to a transmit UE, and the transmit UE performs SL transmission over the resource. Like uplink (UL) transmission over a Uu interface, since the network side does not know a current data buffer status of the UE side, the UE needs to report the current data buffer status of the UE to the network, thereby triggering the network to issue the resource grant. To summarize, the UE sends an SR or initiates random access to the base station, and then sends an SL-buffer status report (BSR). Based on the SL-BSR, the base station can determine that the UE has data to-be-transmitted for SL communication, and estimate a resource required to transmit the data. The base station can schedule a transmission resource for SL communication by using a configured SL radio network temporary identity (RNTI).

Different fields for the SL-BSR are defined as follows:

Destination index (that is, destination address ID): The “destination index” field is used to identify a destination address for SL communication, and the UE sets the value thereof to an index of an associated destination address in a destination address list reported in a SidelinkUEInformation message. If the UE has reported multiple destination address lists in the SidelinkUEInformation message, the UE arranges sequentially the multiple destination address lists in a certain order, so as to index a corresponding destination address. Specifically, since the SidelinkUEInformation message in LTE-V2X defines destination address lists with regard to different frequencies respectively, for a certain destination address, if the destination address can be used for more than one frequencies, the destination address is likely to correspond to multiple destination indexes, thus resulting in redundancy of some destination indexes, and such problem is not yet solved in LTE-V2X. In NR-V2X, the signaling structure of the SidelinkUEInformation message is modified with regard to the problem, i. e. frequency lists are arranged in different destination address structures, thereby solving the problem.

Logical channel group (LCG) ID: this field identifies a group of logical channel(s) whose UE buffer status is being reported. The LCG ID indicates priority information (ProSe per-packet priority (PPPP)) and reliability information (ProSe per-packet reliability (PPPR)) related to data to-be-transmitted. Specifically, the UE reports a data amount associated with one or more PPPP values and/or PPPR values via an SL-BSR. A mapping from a PPPP value and a PPPR value to an LCG can be configured by the base station, and the PPPP value and the PPPR value are reflected by an LCG ID contained in the SL-BSR.

Buffer size: Similar to the definition of an UL-BSR, this field is defined as the total amount of data across all logical channels of an associated LCG after a MAC PDU has been built, containing all data available for transmission at a radio link control (RLC) layer and a packet data convergence protocol (PDCP) layer (the size of an RLC header and the size of a MAC header are not considered).

For NR-V2X, an SL-BSR format is defined in a similar way, and the difference lies in that the destination index extends to 5 bits from 4 bits, the LCG ID extends to 3 bits from 2 bits, and the buffer size extends to 8 bits from 6 bits. Therefore, for each LCG of the same destination address, 2 bytes need to be occupied, and thus it is not necessary to define SL-BSR formats with regard to an even number and an odd number respectively. For triggering of an SL-BSR, it is similar to the triggering conditions of an UL-BSR except for the following conditions:
New data is available for transmission in an RLC entity or a PDCP entity (if there are other data to-be-transmitted, the priority of the new data is higher than the priority of data to-be-transmitted on any LCG belonging to the same destination address, or the destination address currently has no other data to-be-transmitted);
After a resource grant is allocated to data and a padding BSR for an UL channel has been triggered, the number of bits remaining is equal to or greater than the size of an SL-BSR (containing buffer information of at least one LCG of at least one destination address);
An SL-BSR retransmission timer expires, and a MAC entity has data available for SL transmission;
An SL-BSR periodic timer expires.

In LTE-V2X, the same SR resource is used for an SL and an UL and is not differentiated. Therefore, the network-side is unable to distinguish whether a resource request is made for an SL or is made for an UL according to the SR resource received.

In NR-V2X, the usage of an SL SR resource is further optimized.

Firstly, the network can configure the UE to use different SR resources respectively for an UL and an SL, i. e. the problem of using an SR resource for both an SL and an UL in LTE-V2X is solved.

Then, in order to distinguish different services on an SL, the network can configure the UE to use different SR resources with regard to different logical channels of the SL. As such, according to an SR resource, it is possible for the network to not only know that a resource request is triggered by the SL but also know which logical channel of the SL has triggered the resource request.

Further, since an SL-CSI report introduced in NR-V2X is transmitted via an SL MAC CE, a corresponding SL resource needs to be obtained for transmission. Therefore, in NR-V2X, a procedure related to triggering an SR by SL-CSI reporting and a corresponding condition for cancelling the SR are also defined. Specifically, if the size of an SL grant can accommodate SL-CSI reporting that has been triggered but not yet cancelled, an SR triggered by SL-CSI reporting with regard to an associated destination address will be cancelled and a related SR timer will be stopped.

At present, NR V2X only supports a single carrier and a single-carrier-based CSI reporting mechanism. After a multi-carrier mechanism is introduced, the CSI reporting mechanism needs to be enhanced accordingly. At a UE side sending a CSI report, CSI report transmission on a specific carrier needs to be considered.

In order for better understanding of technical solutions of embodiments of the disclosure, the technical solutions of the disclosure will be described in detail below in connection with embodiments. The foregoing related art as an optional scheme can be arbitrarily combined with the technical solutions of embodiments of the disclosure, which shall all belong to the protection scope of embodiments of the disclosure. Embodiments of the disclosure include at least some of the following.

The disclosure provides are a wireless communication method, a terminal device, and a network device, which are beneficial to improving performance of sidelink (SL) transmission.

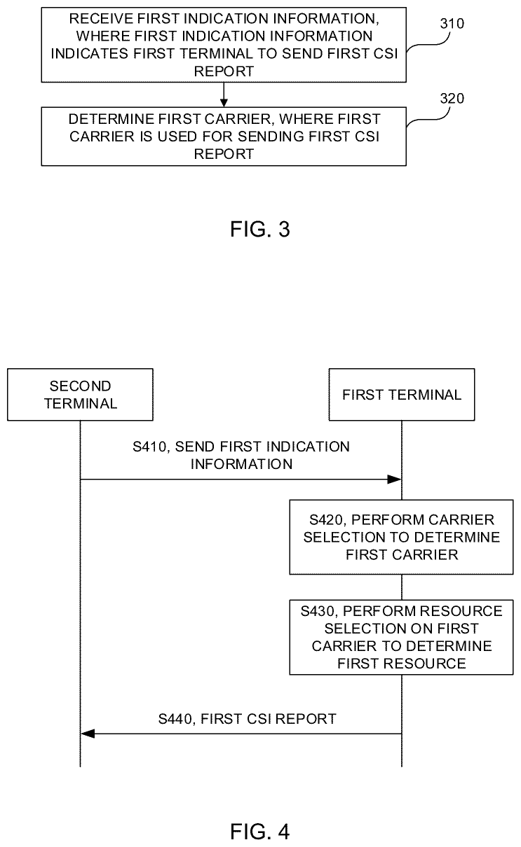

FIG. 3 is a flowchart of a wireless communication method provided in an exemplary embodiment of the disclosure. The method is implemented by a first terminal. The method includes the following.
S310, first indication information is received, where the first indication information indicates a first terminal to send a first CSI report.
S320, a first carrier is determined, where the first carrier is used for sending the first CSI report.

In some embodiments, the method further includes the following. The first CSI report is sent on the first carrier.

In some embodiments, the first indication information is CSI request information. The first terminal receives the CSI request information sent by a second terminal so as to determine the first carrier, and then sends the first CSI report to the second terminal on the first carrier.

In some embodiments, the time at which the first indication information is received by the first terminal is one of: the time at which a physical layer notifies the first indication information to a MAC layer if the first indication information is physical layer information; the time at which MAC layer information is decoded if the first indication information is MAC layer information; or the time at which an RRC layer indicates the first indication information to the MAC layer if the first indication information is RRC layer information.

In some embodiments, there are multiple carriers available for data transmission. After receiving the first indication information, the first terminal needs to perform carrier selection to determine the first carrier, and then sends the first CSI report on the first carrier.

In some embodiments, the first carrier is at least one of: a carrier configured by a network, a carrier configured by the second terminal, a carrier specified in a protocol, a carrier negotiated between two terminals, a default carrier, a carrier for receiving the first indication information, or a carrier for CSI signal reception.

For example, the first carrier is a carrier for receiving the first indication information. After receiving the first indication information, the first terminal sends the first CSI report on the carrier for receiving the first indication information.

For another example, the first carrier is a carrier negotiated between two terminals, that is, the first carrier is a carrier negotiated between the first terminal and the second terminal. After receiving the first indication information sent by the second terminal, the first terminal sends the first CSI report to the second terminal on the carrier negotiated.

It should be noted that, there can be one or more first carriers. The first terminal can send the CSI report on one carrier, or can send the CSI report simultaneously on multiple carriers.

In some embodiments, the method further includes the following. An LCP procedure is performed. Specifically, if the first carrier is a second carrier, a destination address corresponding to the first CSI report and/or a logical channel associated with the destination address and/or a MAC CE for the first CSI report will be selected. If the first carrier is not the second carrier, the destination address corresponding to the first CSI report will not be selected; alternatively, the destination address corresponding to the first CSI report and/or the logical channel associated with the destination address will be selected without selecting the MAC CE for the first CSI report. The second carrier is a carrier in which a current available resource is located.

In some embodiments, the first CSI report will be sent on the first carrier if the destination address corresponding to the first CSI report, the logical channel associated with the destination address, and the MAC CE for the first CSI report are selected.

For example, the first carrier is a carrier in which a current available resource is located, that is, the first carrier currently has a resource available for data transmission and the resource can be used for transmitting the first CSI report. Then the first terminal can select the destination address corresponding to the first CSI report to-be-sent, the logical channel associated with the destination address, and the MAC CE for the first CSI report, and can send the first CSI report on the first carrier. In this case, through the LCP procedure, the CSI report is successfully assembled and carried.

In some embodiments, the first carrier is determined follows. The first carrier is determined from multiple carriers according to CSI configuration information, where the CSI configuration information is specified in a protocol, or is determined by a network device, or is determined by a terminal device, or is preconfigured.

For example, the CSI configuration information can be determined by the first terminal (UE receiving a CSI request).

For another example, the CSI configuration information can be determined by the second terminal (UE sending the CSI request).

In some embodiments, the method further includes the following. First configuration information is received, where the first configuration information indicates the CSI configuration information.

In some embodiments, the method further includes the following. Second configuration information is sent to the network device, where the second configuration information indicates the CSI configuration information.

Optionally, the first terminal sends the second configuration information to the network device via RRC signaling.

In some embodiments, the CSI configuration information includes at least one of: a carrier configuration for reference signal transmission, a carrier configuration for CSI report request information, a carrier configuration for CSI report measurement, a carrier configuration for CSI report transmission, a delay timer value, a time-frequency position of a reference signal, or an antenna configuration.

For example, the first terminal determines the first carrier from multiple carriers according to the carrier configuration for CSI report transmission in the CSI configuration information.

In some embodiments, the first terminal receives the CSI configuration information sent by the second terminal, and then reports the CSI configuration information to the network device via RRC signaling.

In some embodiments, the method further includes the following. A first resource is determined, where the first resource is used for sending the first CSI report.

In some embodiments, the first resource is a resource in the first carrier, and the first resource is used for sending the first CSI report. The first terminal device sends the first CSI report on the first resource in the first carrier.

In some embodiments, the first resource is determined as follows. The first resource is determined by triggering resource selection on the first carrier.

In some embodiments, if there is an available resource in the first carrier, the available resource is determined as the first resource.

For example, in mode 2 (the terminal device autonomously selects a transmission resource from a resource pool to perform communication data transmission), after receiving the first indication information sent by the second terminal, the first terminal performs carrier selection to determine the first carrier, and then triggers resource selection on the first carrier to determine the first resource, so as to send the first CSI report to the second terminal on the first resource in the first carrier.

In other embodiments, the first resource is determined as follows. If there is an available resource in the first carrier before a first timer expires, the available resource is determined as the first resource. If there is no available resource in the first carrier before the first timer expires, a first SR and/or a first BSR is sent to the network device, so as to request the first resource.

In some embodiments, the method further includes the following. Second indication information sent by the network device is received, where the second indication information indicates the first resource.

Optionally, the first BSR contains a destination address ID and/or a logical channel ID.

Optionally, the first timer is a latency requirement timer.

For example, in mode 1 (a transmission resource for the terminal device is allocated by an access-network device, and the terminal device performs communication data transmission over an SL on the transmission resource allocated by the access-network device), after receiving the first indication information sent by the second terminal, the first terminal starts the latency requirement timer. If there is an available resource in the first carrier before the latency requirement timer expires, the first CSI report will be sent on the available resource in the first carrier. If there is no available resource in the first carrier before the latency requirement timer expires, the first terminal triggers a BSR procedure to request from the network device for a resource for sending the first CSI report. Specifically, the first terminal sends the first BSR to the network device, and the network device indicates a resource for sending the first CSI report (a carrier in which the resource is located is a carrier for sending the first CSI report) through the destination address ID (destination address index) and the logical channel ID (LCG ID) in the BSR.

In some embodiments, the first SR is sent to the network device as follows. The first SR is sent according to a first SR configuration corresponding to the first CSI report, where the first SR configuration is configured by a network, or is specified in a protocol, or is a default SR configuration.

In some embodiments, different SR configurations correspond to different SL carriers and/or different CSI reports. The network device can determine a carrier and a resource for sending the first CSI report according to the SR configuration, and then indicate the resource to the first terminal.

In other embodiments, there is only one SR configuration. The network device determines a carrier and a resource for sending the first CSI report according to the CSI configuration (the CSI configuration information) and a corresponding destination address, and then indicates the resource to the first terminal.

For example, in mode 1 (a transmission resource for the terminal device is allocated by an access-network device, and the terminal device performs communication data transmission over an SL on the transmission resource allocated by the access-network device), after receiving the first indication information sent by the second terminal, the first terminal starts the latency requirement timer. If there is an available resource in the first carrier before the latency requirement timer expires, the first CSI report will be sent on the available resource in the first carrier. If there is no available resource in the first carrier before the latency requirement timer expires, the first terminal triggers an SR procedure to request from the network device for a resource for sending the first CSI report. Specifically, the first terminal sends the first SR to the network device, and the network device indicates, through the first SR, a resource required for sending the first CSI report.

FIG. 4 is a flowchart of a wireless communication method provided in an exemplary embodiment of the disclosure. The method includes at least some of the following contents.
S410, a second terminal sends first indication information to a first terminal, where the first indication information indicates the first terminal to send a first CSI report.
S420, the first terminal performs carrier selection to determine a first carrier.
S430, the first terminal performs resource selection on the first carrier to determine a first resource.
S440, the first terminal sends the first CSI report to the second terminal on the first resource in the first carrier.

In some embodiments, the first indication information is CSI request information. The first terminal receives the CSI request information sent by the second terminal so as to determine the first carrier, and then sends the first CSI report to the second terminal on the first carrier.

In some embodiments, the second terminal device receives the first CSI report on the first carrier.

In some embodiments, the time at which the first indication information is received by the first terminal is one of: the time at which a physical layer notifies the first indication information to a MAC layer if the first indication information is physical layer information; the time at which MAC layer information is decoded if the first indication information is MAC layer information; or the time at which an RRC layer indicates the first indication information to the MAC layer if the first indication information is RRC layer information.

In some embodiments, the first carrier is at least one of: a carrier configured by a network, a carrier configured by the second terminal, a carrier specified in a protocol, a carrier negotiated between two terminals, a default carrier, a carrier for receiving the first indication information, or a carrier for CSI signal reception.

In some embodiments, the method further includes the following. An LCP procedure is performed. Specifically, if the first carrier is a second carrier, a destination address corresponding to the first CSI report and/or a logical channel associated with the destination address and/or a MAC CE for the first CSI report will be selected. If the first carrier is not the second carrier, the destination address corresponding to the first CSI report will not be selected; alternatively, the destination address corresponding to the first CSI report and/or the logical channel associated with the destination address will be selected without selecting the MAC CE for the first CSI report. The second carrier is a carrier in which a current available resource is located.

For example, if the first carrier is a carrier in which a current available resource is located, the destination address corresponding to the first CSI report, the logical channel associated with the destination address, and the MAC CE for the first CSI report will be selected to send the first CSI report on the first carrier.

In some embodiments, the first resource is determined as follows. The first resource is determined by triggering resource selection on the first carrier.

In some embodiments, if there is an available resource in the first carrier, the available resource is determined as the first resource.

For example, in mode 2 (the terminal device autonomously selects a transmission resource from a resource pool to perform communication data transmission), after receiving the first indication information sent by the second terminal, the first terminal performs carrier selection to determine the first carrier, and then triggers resource selection on the first carrier to determine the first resource, so as to send the first CSI report to the second terminal on the first resource in the first carrier.

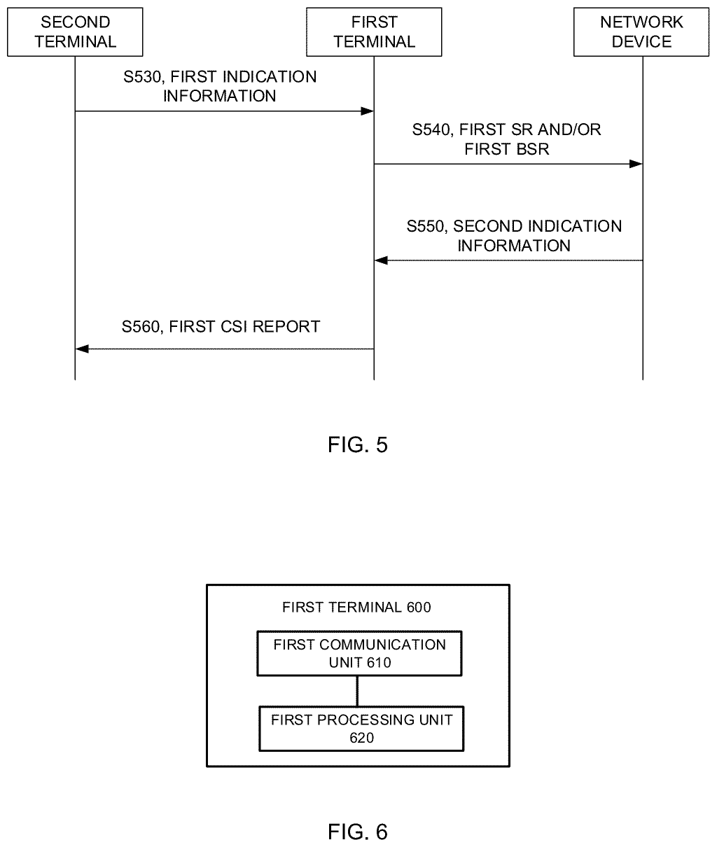

FIG. 5 is a flowchart of a wireless communication method provided in another exemplary embodiment of the disclosure. The method includes at least some of the following contents.
S530, a second terminal sends first indication information to a first terminal, where the first indication information indicates the first terminal to send a first CSI report.
S540, the first terminal sends a first SR and/or a first BSR to a network device to request a first resource, where the first resource is used for the first terminal to send the first CSI report.
S550, the network device sends second indication information to the first terminal, where the second indication information indicates the first resource.
S560, the first terminal sends the first CSI report to the second terminal.

In some embodiments, before S530, the method further includes the following.
S511, the second terminal sends first configuration information to the first terminal, where the first configuration information indicates CSI configuration information.
S512, the first terminal sends second configuration information to the network device, where the second configuration information indicates the CSI configuration information.

For example, the first terminal receives the CSI configuration information sent by the second terminal, and then reports the CSI configuration information to the network device via RRC signaling.

In other embodiments, before S530, the method further includes the following.
S521, the first terminal receives first configuration information sent by the network device, where the first configuration information indicates CSI configuration information.
S522, the first terminal sends second configuration information to the second terminal, where the second configuration information indicates the CSI configuration information.

For example, the first terminal receives the CSI configuration information sent by the network device, and then sends the CSI configuration information to the second terminal.

In some embodiments, the CSI configuration information includes at least one of: a carrier configuration for reference signal transmission, a carrier configuration for CSI report request information, a carrier configuration for CSI report measurement, a carrier configuration for CSI report transmission, a delay timer value, a time-frequency position of a reference signal, or an antenna configuration.

In some embodiments, after receiving the first indication information sent by the second terminal, the first terminal starts a latency requirement timer. If there is no available resource in the first carrier before a first timer expires, the first terminal sends the first SR and/or the first BSR to the network device, so as to request the first resource.

Optionally, the first BSR contains a destination address ID and/or a logical channel ID.

Optionally, the first timer is a latency requirement timer.

In some embodiments, in mode 1 (a transmission resource for the terminal device is allocated by an access-network device, and the terminal device performs communication data transmission over an SL on the transmission resource allocated by the access-network device), after receiving the first indication information sent by the second terminal, the first terminal starts the latency requirement timer. If there is an available resource in the first carrier before the latency requirement timer expires, the first CSI report will be sent on the available resource in the first carrier. If there is no available resource in the first carrier before the latency requirement timer expires, the first terminal triggers a BSR procedure to request from the network device for a resource for sending the first CSI report. Specifically, the first terminal sends the first BSR to the network device, and the network device indicates a resource for sending the first CSI report through the destination address ID (destination address index) and the logical channel ID (LCG ID) in the BSR.

In some embodiments, the first SR is sent to the network device as follows. The first SR is sent according to a first SR configuration corresponding to the first CSI report.

In some embodiments, the network device determines the first resource based on the first SR configuration and a first correspondence, where the first correspondence is a correspondence between an SR configuration and an SL carrier.

Optionally, different SR configurations correspond to different SL carriers. The network device can determine a carrier and a resource for sending the first CSI report according to the SR configuration, and then indicate the resource to the first terminal.

In some embodiments, the SR configuration is configured by a network, or is specified in a protocol, or is a default SR configuration.

In other embodiments, there is only one SR configuration. The network device determines a carrier and a resource for sending the first CSI report according to the CSI configuration (the CSI configuration information) and a corresponding destination address, and then indicates the resource to the first terminal.

For example, in mode 1 (a transmission resource for the terminal device is allocated by an access-network device, and the terminal device performs communication data transmission over an SL on the transmission resource allocated by the access-network device), after receiving the first indication information sent by the second terminal, the first terminal starts the latency requirement timer. If there is an available resource in the first carrier before the latency requirement timer expires, the first CSI report will be sent on the available resource in the first carrier. If there is no available resource in the first carrier before the latency requirement timer expires, the first terminal triggers an SR procedure to request from the network device for a resource for sending the first CSI report. Specifically, the first terminal sends the first SR to the network device, and the network device indicates, through the first SR, a resource required for sending the first CSI report.

The method embodiments of the disclosure have been described in detail above with reference to FIG. 3 to FIG. 5, and the apparatus embodiments of the disclosure will be described in detail below with reference to FIG. 6 to FIG. 8. It should be understood that, the apparatus embodiments and the method embodiments correspond to each other, and for similar illustration, reference can be made to the method embodiments.

FIG. 6 is a schematic block diagram of a first terminal 600 according to embodiments of the disclosure. As illustrated in FIG. 6, the first terminal 600 includes a first communication unit 610 and a first processing unit 620. The first communication unit 610 is configured to receive first indication information, where the first indication information indicates the first terminal to send a first CSI report. The first processing unit 620 is configured to determine a first carrier, where the first carrier is used for sending the first CSI report.

In some embodiments, the first carrier is at least one of: a carrier configured by a network, a carrier configured by a second terminal, a carrier specified in a protocol, a carrier negotiated between two terminals, a default carrier, a carrier for receiving the first indication information, or a carrier for CSI signal reception.

In some embodiments, the first communication unit is further configured to send the first CSI report on the first carrier.

In some embodiments, the first processing unit is further configured to perform an LCP procedure.

In some embodiments, the LCP procedure includes the following. If the first carrier is a second carrier, a destination address corresponding to the first CSI report and/or a logical channel associated with the destination address and/or a MAC CE for the first CSI report will be selected. If the first carrier is not the second carrier, the destination address corresponding to the first CSI report will not be selected; alternatively, the destination address corresponding to the first CSI report and/or the logical channel associated with the destination address will be selected without selecting the MAC CE for the first CSI report. The second carrier is a carrier in which a current available resource is located.

In some embodiments, the first communication unit is further configured to send the first CSI report on the first carrier if the destination address corresponding to the first CSI report, the logical channel associated with the destination address, and the MAC CE for the first CSI report are selected.

In some embodiments, the first carrier is determined as follows. A first resource is determined, where the first resource is a resource in the first carrier, and the first resource is used for sending the first CSI report.

In some embodiments, the first resource is determined as follows. The first resource is determined by triggering resource selection on the first carrier.

In some embodiments, the first resource is determined as follows. If there is an available resource in the first carrier before a first timer expires, the available resource is determined as the first resource. If there is no available resource in the first carrier before the first timer expires, a first SR and/or a first BSR is sent to the network device, so as to request the first resource. In some embodiments, the first BSR contains a destination address ID and/or a logical channel ID.

In some embodiments, the first SR is sent to the network device as follows. The first SR is sent according to a first SR configuration corresponding to the first CSI report, where the first SR configuration is configured by a network, or is specified in a protocol, or is a default SR configuration.

In some embodiments, the first processing unit is further configured to receive second indication information sent by the network device, where the second indication information indicates the first resource.

In some embodiments, the first carrier is determined as follows. The first carrier is determined from multiple carriers according to CSI configuration information, where the CSI configuration information is specified in a protocol, or is determined by the network device, or is determined by a terminal device, or is preconfigured.

In some embodiments, the first communication unit is further configured to receive first configuration information, where the first configuration information indicates the CSI configuration information.

In some embodiments, the first communication unit is further configured to send second configuration information to the network device, where the second configuration information indicates the CSI configuration information.

Optionally, the first terminal sends the second configuration information to the network device via RRC signaling.

In some embodiments, the CSI configuration information includes at least one of: a carrier configuration for reference signal transmission, a carrier configuration for CSI report request information, a carrier configuration for CSI report measurement, a carrier configuration for CSI report transmission, a delay timer value, a time-frequency position of a reference signal, or an antenna configuration.

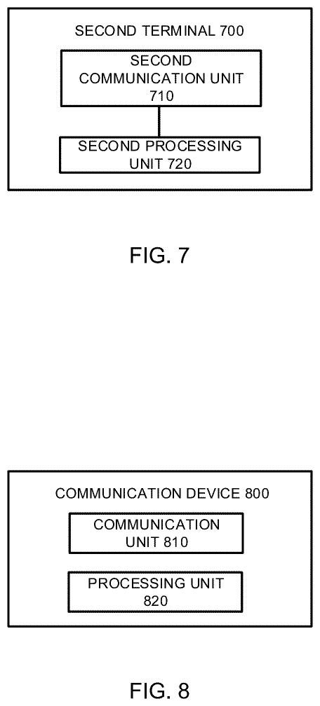

FIG. 7 is a schematic block diagram of a second terminal 700 according to embodiments of the disclosure. As illustrated in FIG. 7, the second terminal 700 includes a second communication unit 710 and a second processing unit 720. The second communication unit 710 is configured to send first indication information, where the first indication information indicates a first terminal to send a first CSI report. The second processing unit 720 is configured to determine a first carrier, where the first carrier is used for receiving the first CSI report.

In some embodiments, the second communication unit is further configured to send first configuration information, where the first configuration information indicates CSI configuration information.

In some embodiments, the CSI configuration information includes at least one of: a carrier configuration for reference signal transmission, a carrier configuration for CSI report request information, a carrier configuration for CSI report measurement, a carrier configuration for CSI report transmission, a delay timer value, a time-frequency position of a reference signal, or an antenna configuration.

In some embodiments, the second communication unit is further configured to receive, on the first carrier, the first CSI report sent by the first terminal device.

FIG. 8 is a schematic block diagram of a network device 800 according to embodiments of the disclosure. As illustrated in FIG. 8, the network device 800 includes a communication unit 810 and a processing unit 820. The communication unit 810 is configured to receive a first SR and/or a first BSR sent by a first terminal. The processing unit 820 is configured to determine a first resource according to the first SR and/or the first BSR, where the first resource is used for the first terminal to send a first CSI report.

In some embodiments, the first BSR contains a destination address ID and/or a logical channel ID.

In some embodiments, the first resource is determined as follows. The first resource is determined according to the destination address ID and the logical channel ID.

In some embodiments, the first resource is determined as follows. The first resource is determined according to the first SR and CSI configuration information, where the CSI configuration information is specified in a protocol, or is determined by the network device, or is preconfigured, or is determined by a second terminal.

In some embodiments, the first resource is determined as follows. A first SR configuration is determined according to the first SR, and the first resource is determined based on the first SR configuration, where the first SR configuration is configured by a network, or is specified in a protocol, or is a default SR configuration.

In some embodiments, the first resource is determined based on the first SR configuration as follows. The first resource is determined based on the first SR configuration and a first correspondence, wherein the first correspondence is a correspondence between an SR configuration and an SL carrier.

In some embodiments, the communication unit is further configured to send second indication information to the first terminal, where the second indication information indicates the first resource.

In some embodiments, the communication unit is further configured to receive second configuration information, where the second configuration information indicates the CSI configuration information.

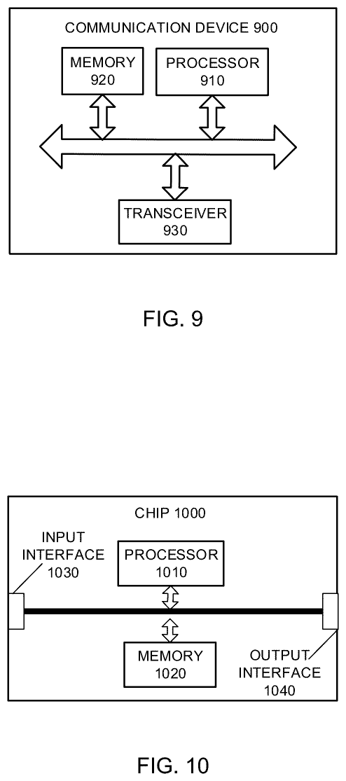

FIG. 9 is a schematic structural diagram of a communication device 900 provided in embodiments of the disclosure. The communication device 900 illustrated in FIG. 9 includes a processor 910. The processor 910 can invoke and execute computer programs from a memory, so as to implement the method in embodiments of the disclosure.

In some embodiments, as illustrated in FIG. 9, the communication device 900 can further include a memory 920. The processor 910 can invoke and execute computer programs from the memory 920, to implement the method in embodiments of the disclosure.

The memory 920 can be a separate device independent of the processor 910, or can be integrated into the processor 910.

In some embodiments, as illustrated in FIG. 9, the communication device 900 can further include a transceiver 930. The processor 910 can control the transceiver 930 to communicate with other devices, and specifically, can send information or data to other devices or receive information or data sent by other devices.

The transceiver 930 can include a transmitter and a receiver. The transceiver 930 can further include an antenna, where one or more antennas can be provided.

In some embodiments, the communication device 900 can specifically be a network device in embodiments of the disclosure, and the communication device 900 can implement corresponding processes implemented by the network device in various methods in embodiments of the disclosure, which are not described again herein for brevity.

In some embodiments, the communication device 900 can specifically be a terminal device in embodiments of the disclosure, and the communication device 900 can implement corresponding processes implemented by the terminal device in various methods in embodiments of the disclosure, which are not described again herein for brevity.

FIG. 10 is a schematic structural diagram of a chip according to embodiments of the disclosure. The chip 1000 illustrated in FIG. 10 includes a processor 1010. The processor 1010 can invoke and execute computer programs from a memory, so as to implement the method in embodiments of the disclosure.

Optionally, as illustrated in FIG. 10, the chip 1000 can further include a memory 1020, where the processor 1010 can invoke and execute computer programs from the memory 1020, to implement the method in embodiments of the disclosure.

The memory 1020 can be a separate device independent of the processor 1010, or can be integrated into the processor 1010.

Optionally, the chip 1000 can further include an input interface 1030. The processor 1010 can control the input interface 1030 to communicate with other devices or chips, and specifically, can acquire information or data sent by other devices or chips.

Optionally, the chip 1000 can further include an output interface 1040. The processor 1010 can control the output interface 1040 to communicate with other devices or chips, and specifically, can output information or data to other devices or chips.

Optionally, the chip can be applied to the first device in embodiments of the disclosure, and the chip can implement a corresponding process implemented by the first device in various methods in embodiments of the disclosure, which is not described again herein for brevity.

Optionally, the chip can be applied to the first terminal in embodiments of the disclosure, and the chip can implement corresponding processes implemented by the first terminal in various methods in embodiments of the disclosure, which are not described again herein for brevity.

It should be understood that, the chip described in embodiments of the disclosure can also be referred to as a system-on-chip (SoC).

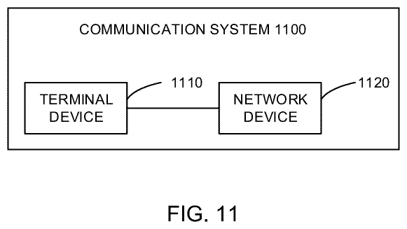

FIG. 11 is a schematic block diagram of a communication system 1100 provided in embodiments of the disclosure. As illustrated in FIG. 11, the communication system 1100 includes a terminal device 1110 and a network device 1120.

The terminal device 1110 can be configured to implement corresponding functions implemented by the terminal device in the foregoing method, and the network device 1120 can be configured to implement corresponding functions implemented by the network device in the foregoing method, which are not described again herein for brevity.

With the above technical solutions, the first terminal can receive the first indication information sent by other devices (e. g. the second terminal), where the first indication information indicates the first terminal to send the first CSI report. Then, the first terminal determines the first carrier, where the first carrier is used for sending the first CSI report. Further, the first terminal can send the first CSI report on the first carrier, thereby providing a method for CSI reporting in a multi-carrier mechanism.

It should be understood that, the processor in embodiments of the disclosure can be an integrated circuit chip with signal processing capabilities. During implementation, each step of the foregoing method embodiments can be completed by an integrated logic circuit of hardware in the processor or an instruction in the form of software. The processor can be a general-purpose processor, a digital signal processor (DSP), an application specific integrated circuit (ASIC), a field programmable gate array (FPGA), or other programmable logic devices, discrete gates or transistor logic devices, discrete hardware components. The methods, steps, and logic blocks disclosed in embodiments of the disclosure can be implemented or executed. The general-purpose processor can be a microprocessor, or the processor can be any conventional processor or the like. The steps of the method disclosed in embodiments of the disclosure can be directly implemented by a hardware decoding processor, or can be performed by hardware and software modules in the decoding processor. The software module can be located in a storage medium such as a random access memory (RAM), a flash memory, a read only memory (ROM), a programmable ROM (PROM), or an electrically erasable programmable memory, registers, and the like. The storage medium is located in the memory. The processor reads the information in the memory, and completes the steps of the method described above with the hardware thereof.

It can be understood that, the memory in embodiments of the disclosure can be a volatile memory or a non-volatile memory, or can include both the volatile memory and the non-volatile memory. The non-volatile memory can be a ROM, a PROM, an erasable PROM (EPROM), an electrically EPROM (EEPROM), or flash memory. The volatile memory can be a RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It should be noted that, the memory of the systems and methods described in the disclosure is intended to include, but is not limited to, these and any other suitable types of memory.

It should be understood that, the memory above is intended for illustration rather than limitation. For example, the memory in embodiments of the disclosure can also be an SRAM, a DRAM, an SDRAM, a DDR SDRAM, an ESDRAM, an SLDRAM, a DR RAM, etc. In other words, the memory in embodiments of the disclosure is intended to include, but is not limited to, these and any other suitable types of memory.

Embodiments of the disclosure further provide a computer-readable storage medium. The computer-readable storage medium is configured to store computer programs.

Optionally, the computer-readable storage medium can be applied to the first device in embodiments of the disclosure, and the computer programs are operable with a computer to execute corresponding operations implemented by the first device in various methods in embodiments of the disclosure, which will not be described again herein for the sake of brevity.

Optionally, the computer-readable storage medium can be applied to the first terminal in embodiments of the disclosure, and the computer programs are operable with a computer to execute corresponding operations implemented by the first terminal in various methods in embodiments of the disclosure, which will not be described again herein for the sake of brevity.

Embodiments of the disclosure further provide a computer program product. The computer program product includes computer program instructions.

Optionally, the computer program product can be applied to the first device in embodiments of the disclosure, and the computer program instructions are operable with a computer to perform corresponding operations implemented by the first device in various methods in embodiments of the disclosure, which will not be described again herein for the sake of brevity.

Optionally, the computer program product can be applied to the first terminal in embodiments of the disclosure, and the computer program instructions are operable with a computer to perform corresponding operations implemented by the first terminal in various methods in embodiments of the disclosure, which will not be described again herein for the sake of brevity.

Embodiments of the disclosure further provide a computer program.

Optionally, the computer program can be applied to the first device in embodiments of the disclosure. The computer program, when executed by a computer, is operable to implement corresponding operations implemented by the first device in various methods in embodiments of the disclosure, which will not be described again herein for the sake of brevity.

Optionally, the computer program can be applied to the first terminal in embodiments of the disclosure. The computer program, when executed by a computer, is operable to implement corresponding operations implemented by the first terminal in various methods in embodiments of the disclosure, which will not be described again herein for the sake of brevity.

Those of ordinary skill in the art will appreciate that units and algorithmic operations of various examples described in connection with embodiments of the disclosure can be implemented by electronic hardware or by a combination of computer software and electronic hardware. Whether these functions are performed by means of hardware or software depends on the application and the design constraints of the associated technical solution. Those skilled in the art can use different methods with regard to each particular application to implement the described functionality, but such methods should not be regarded as lying beyond the scope of the disclosure.

It will be evident to those skilled in the art that, for the sake of convenience and brevity, in terms of the specific working processes of the foregoing systems, apparatuses, and units, reference can be made to the corresponding processes in the foregoing method embodiments, which will not be repeated herein.

It will be appreciated that the systems, apparatuses, and methods disclosed in embodiments of the disclosure can also be implemented in various other manners. For example, the above apparatus embodiments are merely illustrative, e.g., the division of units is only a division of logical functions, and other manners of division can be available in practice, e.g., multiple units or assemblies can be combined or can be integrated into another system, or some features can be ignored or skipped. In other respects, the coupling or direct coupling or communication connection as illustrated or discussed can be an indirect coupling or communication connection through some interface, device, or unit, and can be electrical, mechanical, or otherwise.

Separated units as illustrated can or cannot be physically separated. Components displayed as units can or cannot be physical units, and can reside at one location or can be distributed to multiple networked units. Some or all of the units can be selectively adopted according to practical needs to achieve desired objectives of the disclosure.

In addition, various functional units described in various embodiments of the disclosure can be integrated into one processing unit or can be present as a number of physically separated units, and two or more units can be integrated into one.

If the functions are implemented as software functional units and sold or used as standalone products, they can be stored in a computer-readable storage medium. Based on such an understanding, the essential technical solution, or the portion that contributes to the prior art, or part of the technical solution of the disclosure can be embodied as software products. The computer software products can be stored in a storage medium and can include multiple instructions that, when executed, can cause a computer device, e.g., a personal computer, a server, a network device, etc., to execute some or all operations of the methods described in various embodiments of the disclosure. The above storage medium can include various kinds of media that can store program codes, such as a universal serial bus (USB) flash disk, a mobile hard drive, a ROM, a RAM, a magnetic disk, or an optical disk.

The foregoing elaborations are merely implementations of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

I/We claim:

1. A wireless communication method, performed by a first terminal and comprising:
receiving first indication information, wherein the first indication information indicates the first terminal to send a first channel state information (CSI) report; and
determining a first carrier, wherein the first carrier is used for sending the first CSI report.

2. The method of claim 1, wherein the first carrier is at least one of:
a carrier configured by a second terminal, a carrier negotiated between two terminals, a carrier for receiving the first indication information, or a carrier for CSI signal reception.

3. The method of claim 1, further comprising:
determining a first resource, wherein the first resource is used for sending the first CSI report.

4. The method of claim 3, wherein determining the first resource comprises:
when there is an available resource in the first carrier, determining the available resource as the first resource.

5. The method of claim 4, wherein the first carrier is a carrier where the available resource is located, the available resource can be used for data transmission and can be used for transmitting the first CSI report.

6. The method of claim 3, wherein:
determining the first carrier comprises:
after receiving the first indication information sent by a second terminal, performing carrier selection to determine the first carrier; and
determining the first resource comprises:
triggering resource selection on the first carrier to determine the first resource, to send the first CSI report to the second terminal in the first carrier on the first resource.

7. The method of claim 3, wherein determining the first resource comprises:
when there is no available resource in the first carrier before a first timer expires, sending a first scheduling request (SR) and/or a first buffer status report (BSR) to a network device to request the first resource.

8. The method of claim 7, further comprising:
receiving second indication information sent by the network device, wherein the second indication information indicates the first resource.

9. The method of claim 1, further comprising:
sending the first CSI report on the first carrier.

10. The method of claim 1, further comprising:
performing a logical channel prioritization (LCP) procedure, wherein the LCP procedure comprises:
when the first carrier is a carrier in which a current available resource is located, selecting a destination address corresponding to the first CSI report and/or a logical channel associated with the destination address and/or a media access control-control element (MAC CE) for the first CSI report.

11. The method of claim 10, wherein the first CSI report is sent on the first carrier when the destination address corresponding to the first CSI report, the logical channel associated with the destination address, and the MAC CE for the first CSI report are selected.

12. A first terminal device, comprising:
a transceiver;
a processor; and
a memory storing a computer program which, when executed by the processor, causes the first terminal device to:
cause the transceiver to receive first indication information, wherein the first indication information indicates the first terminal device to send a first channel state information (CSI) report; and
determine a first carrier, wherein the first carrier is used for sending the first CSI report.

13. The first terminal device of claim 12, wherein the first carrier is at least one of:
a carrier configured by a second terminal, a carrier negotiated between two terminals, a carrier for receiving the first indication information, or a carrier for CSI signal reception.

14. The first terminal device of claim 12, wherein the processor is further configured to:
determine a first resource, wherein the first resource is used for sending the first CSI report.

15. The first terminal device of claim 14, wherein the processor configured to determine the first resource is configured to:
when there is an available resource in the first carrier, determine the available resource as the first resource.

16. The first terminal device of claim 14, wherein the processor configured to determine the first resource is configured to:
when there is no available resource in the first carrier before a first timer expires, cause the transceiver to send a first scheduling request (SR) and/or a first buffer status report (BSR) to a network device to request the first resource.

17. The first terminal device of claim 16, wherein the transceiver is further configured to:
receive second indication information sent by the network device, wherein the second indication information indicates the first resource.

18. The first terminal device of claim 12, wherein the transceiver is further configured to:
send the first CSI report on the first carrier.

19. The first terminal device of claim 12, wherein the processor is further configured to:
perform a logical channel prioritization (LCP) procedure, wherein the LCP procedure comprises:
when the first carrier is a carrier in which a current available resource is located, select a destination address corresponding to the first CSI report and/or a logical channel associated with the destination address and/or a media access control-control element (MAC CE) for the first CSI report.

20. A chip, comprising:
a processor; and
a memory storing a computer program which, when executed by the processor, causes a device equipped with the chip to:
receive first indication information, wherein the first indication information indicates a first terminal to send a first channel state information (CSI) report; and
determine a first carrier, wherein the first carrier is used for sending the first CSI report.
